(19) United States
(12) Patent Application Publication
(10) Pub. No.: US 2025/0370524 A1
(43) Pub. Date: Dec. 4, 2025

(54) ELECTRIC POWER SUPPLY CONTROL DEVICE AND ASSOCIATED METHOD

(71) Applicant: SAGEMCOM ENERGY & TELECOM SAS, BOIS-COLOMBES (FR)

(72) Inventors: Henri TEBOULLE, BOIS-COLOMBES (FR); Christophe GRINCOURT, BOIS-COLOMBES (FR)

(21) Appl. No.: 19/224,577

(22) Filed: May 30, 2025

(30) Foreign Application Priority Data
May 30, 2024 (FR) 2405575

(51) Int. Cl. G06F 1/26; G06F 1/3215; H02J 13/00

(52) U.S. Cl. CPC G06F 1/266; G06F 1/3215; H02J 13/00002; H02J 13/00004; H02J 13/00036; H02J 2310/14; H02J 2310/54; H02J 2310/64

(57) ABSTRACT

The present invention especially discloses a method and a device for implementing such a method of controlling the electricity supply to a second group of appliances including at least one appliance, the method being implemented by a device comprising a first processor designed to carry out electricity consumption measurements, a second processor, and a shut-off switch controlled by the second processor to trigger or stop the power supply to the second group, the method includes obtaining the total electricity consumption of a first group of appliances and the second group of appliances over a period of time, hysteresis operation, including shutting off the power supply if total consumption exceeds the first threshold, and power supply recovery if total consumption falls below the second threshold, and repeating the previous steps over successive periods of time.

### CROSS-REFERENCE TO RELATED APPLICATIONS

The present application claims priority to French Application No. 2405575 filed with the Intellectual Property Office of France on May 30, 2024, which is incorporated herein by reference in its entirety for all purposes.

### TECHNICAL FIELD

The various exemplary embodiments described in the present disclosure relate to an electricity supply control device and a method implemented by this device. The disclosed device is especially suitable for charging an electric vehicle or powering appliances such as electric heaters or the like, through a single electrical outlet. The device can be an electricity meter.

### BACKGROUND

Domestic electricity consumption is evolving, especially with the emergence of new needs such as the need to be able to charge an electric vehicle. This generates high levels of consumption over long periods of the day, which can conflict with other types of consumption. However, electricity suppliers generally impose a maximum usage power in subscriber contracts. If this maximum usage power is exceeded for any length of time, the customer's electricity meter can simply cut off the electricity supply.

There is a need to control electricity consumption taking this constraint into account.

### SUMMARY

A first aspect of the present disclosure relates to a method of controlling the electricity supply to a second group of appliances including at least one appliance, the method being implemented by a device comprising a first processor designed to carry out electricity consumption measurements, a second processor, and a shut-off switch controlled by the second processor to trigger or stop the power supply to the second group, the method comprising:
obtaining, by means of the second processor, the total electricity consumption of a first group of appliances and of the second group of appliances over a period of time, the total electricity consumption being determined by the first processor; the duration of the time period being less than a maximum duration during which the power required by the two groups may be greater than a maximum power to be complied with;
determining whether the total consumption is less than a second threshold, and if so, closing the shut-off switch to enable power supply to the second group;
determining whether the total consumption is greater than a first threshold, and if so, opening the shut-off switch to suspend power supply to the second group;
the first threshold being less than a maximum consumption threshold to be complied with for the total electrical consumption; the second threshold being less than the first threshold, the second threshold being greater than a minimum consumption per period over a time interval including a plurality of consecutive periods of the same duration;
repeating the previous steps over successive periods of time.

This method can be applied to the power supply of any appliance with significant consumption (for example, greater than or equal to 10% of the subscribed power of an electrical installation over a given period).

The minimum margins taken between the first threshold and the maximum consumption threshold to be respected on the one hand, and between the second threshold and the minimum consumption threshold on the other, can be defined to reduce the impact of noise in consumption measurements. It should be noted that according to some embodiments, these thresholds and especially the first threshold can be chosen with a greater margin to influence the frequency of opening and closing of the shut-off switch.

According to one or more exemplary embodiments, the maximum power consumption is a function of the maximum power to be complied with.

This establishes an equivalence between the subscribed power to be complied with and the maximum consumption to be complied with, over a period of time. Subscribed power is expressed in kW and corresponds to the power not to be exceeded for a certain period of time—for example, twenty minutes. The maximum energy that can be consumed during the same period is expressed in kWh and corresponds to the energy consumed at maximum power during the same period.

According to one or more exemplary embodiments, the first threshold has a single value.

According to one or more exemplary embodiments, the first threshold is a function of the time of day.

According to one or more exemplary embodiments, the method comprises assigning to the first threshold a first value (609) for a first time-dependent electricity tariff and a second value (610) for a second time-dependent electricity tariff, the first tariff being greater than the second tariff and the first value being less than the second value.

According to one or more exemplary embodiments, the method comprises determining the maximum power, Pmax, required by the second group over said duration, the first threshold and the second threshold being selected to comply with the relationship

$$First Threshold - Second Threshold > Pmax * duration of a period$$

According to one or more exemplary embodiments, the time interval is one day.

According to one or more exemplary embodiments, the second group of appliances comprises an electric car charger.

A second aspect of the present disclosure relates to a device for controlling the electricity supply to a second group of appliances including at least one appliance, the device comprising a first processor designed to perform electricity consumption measurements, a second processor, and a shut-off switch controlled by the second processor to trigger or stop the power supply to the second group, enabling obtaining the total electricity consumption of the first group of appliances and of a second group of appliances over a period of time, the duration of the period of time being less than a maximum duration during which the power required by the two groups may be greater than a maximum power to be complied with, the second processor being configured to drive the device to carry out:
determining whether the total consumption is less than a second threshold, and if so, closing the shut-off switch to enable power supply to the second group;
determining whether the total consumption is greater than a first threshold, and if so, opening the shut-off switch to suspend power supply to the second group;
the first threshold being less than a maximum consumption threshold to be complied with for the total electrical consumption; the second threshold being less than the first threshold, the second threshold being greater than a minimum consumption per period over a time interval including a plurality of consecutive periods of the same duration;
repeating the previous steps over successive periods of time.

According to one or more exemplary embodiments, the maximum power consumption is a function of the maximum power to be complied with.

According to one or more exemplary embodiments, the device is an electricity meter comprising a circuit breaker controlled by the second processor, the circuit breaker being arranged between a phase input of an electricity supply network and the shut-off switch, the power supply to the first group being carried out via a phase between the circuit breaker and the shut-off switch, and the power supply to the second group being carried out via a phase at the output of the shut-off switch.

According to one or more exemplary embodiments, the shut-off switch is a power relay.

According to one or more exemplary embodiments, the shut-off switch is connected to the circuit breaker via a measuring shunt.

According to one or more exemplary embodiments, the output of the shut-off switch is configured to be connected to an electrical outlet suitable for connecting the second group of appliances.

According to one or more exemplary embodiments, the device disclosed hereinbefore is configured to implement the methods disclosed hereinbefore. Also disclosed is a computer program product comprising instructions which when executed by at least one processor cause such a method to be implemented.

Also disclosed is a computer-readable storage medium comprising instructions which when executed by a processor cause such a method to be implemented. In one embodiment, the storage medium is non-transitory.

### BRIEF DESCRIPTION OF THE FIGURES

The embodiments will be better understood in light of the following detailed description and the accompanying drawings, which are given by way of illustration only and therefore do not limit the present disclosure.

FIG. 1 is a schematic diagram of a meter according to one or more non-limiting exemplary embodiments.

FIG. 2 is a graph showing an example of a subscriber's charging curves in the event that one of the methods described is not implemented.

FIG. 3 is a graph showing an example of a subscriber's charging curves when a method according to a first exemplary embodiment is implemented.

FIG. 4 is a graph showing an example of a subscriber's charging curves when a method according to a second exemplary embodiment is implemented.

FIG. 5 is a flowchart of a method according to the first exemplary embodiment.

FIG. 6 is a flowchart of a method according to the second exemplary embodiment.

### DETAILED DESCRIPTION

Various embodiments will now be described in more detail, by way of non-limiting examples, with reference to the drawings accompanying the present disclosure and illustrating certain exemplary embodiments.

The specific structural and functional details disclosed herein are non-limiting examples. The embodiments disclosed here may undergo various modifications and alternative forms. The subject matter of the disclosure may be embodied in many different forms and should not be construed as being limited solely to the embodiments presented herein as illustrative examples. It should be understood that there is no intention to limit the embodiments to the particular forms described in the remainder of this document.

According to one or more exemplary embodiments, a device and a method for controlling an electricity supply circuit are presented. It should be noted that the control is carried out in real time and ensures that the power subscribed by the subscriber to whom the meter is linked is not exceeded for more than an authorized period. Moreover, it is not necessary to know in advance the power required in real time by this power supply circuit. The device is advantageously an electricity meter or integrated into an electricity meter, but can also be implemented as a separate device, which has access to certain information relating to the total instantaneous electricity consumption of the location concerned by a maximum power subscribed with an electricity supplier.

According to one or more exemplary embodiments, in the context of electricity supply subject to the constraint of complying with a maximum power consumption, two separate electricity supply circuits are provided. The first circuit is intended for conventional domestic electricity consumption. The second circuit, which is the power supply circuit to be controlled using the disclosed methods, is reserved for supplying power to one or more appliances requiring high consumption over long periods, for example an entire day or a large part of the day. These include charging an electric vehicle or even electric heaters. Overall consumption via these two circuits is superimposed on the maximum power constraint to be complied with. According to one or more exemplary embodiments, the second circuit is opened and closed as a function of overall consumption in order to comply with the constraints imposed.

The second circuit can be opened and closed using a shut-off switch such as, for example, a power relay. The shut-off switch is controlled by a suitable processor, which can advantageously be a processor already present in the device for managing the first circuit.

Global consumption thresholds are defined and used to set up hysteresis operation, the second circuit being switched off when global consumption exceeds a high threshold, and the second circuit being switched on again when consumption falls below a low threshold.

Priority is therefore given to consumption of the first circuit. A user will be able to operate their domestic appliances normally, without being affected by the opening or closing of the second circuit. Appliances that consume large amounts of power over long periods will be powered intermittently if necessary, which will be generally harmless and transparent for the user in view of the applications of the second circuit.

Thresholds can be set manually or automatically, according to the exemplary embodiments and their variants.

Two exemplary embodiments will be described. In the first example, the high threshold is at a single level during the day. Since the level of the high threshold affects the frequency at which the second circuit cuts off and closes, the inventors propose in the second example to use this feature advantageously to vary the level of the high threshold during the day. This variation can be used, for example, to adapt especially to another consumption constraint that depends on the time of day, such as the cost of electricity: in peak hours (high tariff hours), the high threshold will be set at a lower level than in off-peak hours (low tariff hours) to trigger more frequent opening of the second circuit and thus reduce charging time in peak hours.

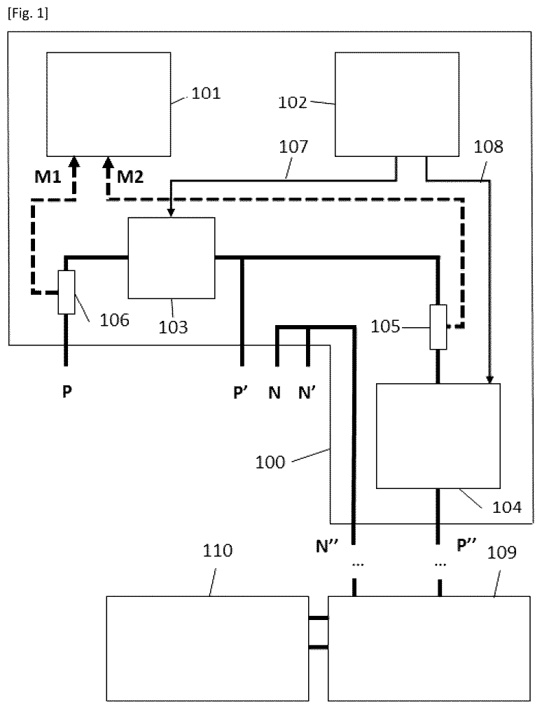

FIG. 1 is a block diagram showing an exemplary implementation of a device 100 applicable to both exemplary embodiments, noting that the structure shown is for illustrative purposes to clarify the point, and that other implementations may be used. As shown in FIG. 1, the device 100 is an electricity meter. According to this same example, this meter is single-phase, but the present disclosure can easily be adapted to a multi-phase and especially three-phase context by monitoring overall consumption on one of the phases. The letter ‘P’ indicates phase and the letter ‘N’ indicates electrical neutral, with P and N (without apostrophes) representing the connection to the electricity supplier's network. The meter 100 typically comprises a metrology processor 101 and a circuit breaker 103. The metrology processor 101 measures currents, voltages and/or energy consumption. In the example shown in FIG. 1, these quantities are measured (measurement M1 in FIG. 1) via a measuring shunt 106, located between the phase P and the circuit breaker 103. An application processor 102 controls the state of the circuit breaker 103 by means of a control signal 107. The processor 102 activates the circuit breaker especially when the power consumed exceeds the subscriber's subscribed power, for example when this excess is detected over a time interval exceeding a threshold, referred to as threshold T1 in the following (T1=20 minutes, for example).

A phase P′ (or primary phase) at the output of the circuit breaker 103 represents the phase at the meter output. In the context of this example, the phase P′ is the phase by which the space associated with the meter is supplied, excluding electric vehicle charging. The phase P′ is also known as the main phase. A neutral N′ at the meter output, associated with the phase P′, is connected to the neutral N at the meter input.

According to the present exemplary embodiment, the meter comprises, in parallel with the conventional phase circuit P′ (first circuit mentioned above), a phase circuit P″ (second circuit) designed to supply power to one or more electrical appliances 110 via one (or more) electrical outlet(s) 109 connected to the (same) phase P″ and neutral N″. The electrical outlet 109 is, for example, a dedicated wall outlet. It should be noted that the electrical outlet 109 can be connected at the meter output to other circuits depending on the appliance(s) to be supplied with electricity (such as 110).

In the following, the example of charging an electric vehicle will be considered, but it is quite clear that the disclosure is not limited to this particular context and that charging of other appliances can be implemented.

In relation to charging an electric vehicle, ‘EVCS’ is used to refer either to the charging function as such, or to the various components associated with this function. The acronym EVCS stands for ‘electric vehicle charging station’.

The EVCS phase circuit includes a power relay 104, one input of which is connected to the phase P′ at the output of the circuit breaker 103 via a measuring shunt 105. The measuring shunt 105 is optional. The metrological processor can measure the current, voltage, and/or consumption specifically of the second circuit, in this case the consumption due to vehicle charging via the shunt 105 (measurement M2) of the EVCS phase circuit. The output phase of the power relay 104 is designated P″ (or secondary phase). A neutral N″ at the meter output, associated with the phase P″, is connected to the neutral N. P″ and N″ are used to supply the EVCS electrical outlet 109. The application processor 102 controls the state of the power relay 104 via a control signal 108. In the present exemplary embodiments, the application processor acts on the power relay 104 to control the charging of the electric vehicle.

According to a particular embodiment, the EVCS measuring shunt 105 is optional. In fact, all that is needed to implement the disclosed method of controlling vehicle charging is to know the total instantaneous power (vehicle charging and domestic consumption charging).

In an embodiment variant described later, the shunt 105 can be used to automatically set charging trigger and stop thresholds (high and low thresholds) as described later. If the shunt 105 is not present, thresholds can be programmed manually, for example.

It should be noted that the meter structure shown above is for illustrative purposes only. Some components may be absent, while others may be present. For example, a meter will include a communication interface for reading its consumption data. In addition, certain functions, presented for greater clarity by separate components, can be grouped together in a single component, or spread across several components. For example, a single processor can be used instead of the two processors shown, although it is common practice to use two separate processors for metrology on the one hand and other applications on the other (including, especially, the circuit breaker control). Other meter structures can therefore be envisaged.

The device 1 also includes a non-volatile memory having software code. When the software code is executed by the processor 102, it causes the device 100 to implement one of the methods described.

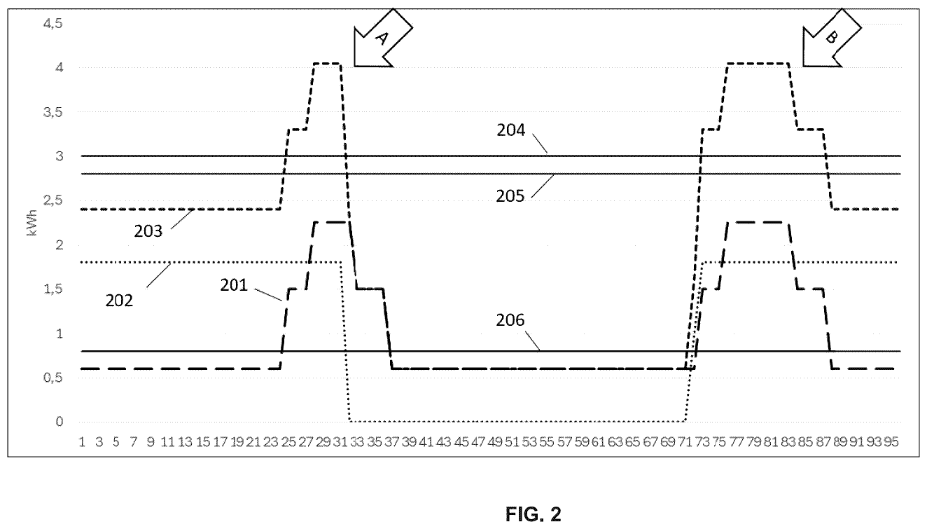

FIG. 2 is a graph showing an example of a customer's charging curves as read by their meter in the context of domestic consumption. In the example shown in FIG. 2, the charging of the electric vehicle is not controlled—this charging can be carried out continuously.

Charging curves in kWh are shown over a 24-hour period, divided into 96 15-minute periods.

The charging curves shown are:
domestic charging curve only 201, excluding electric vehicle charging;
the charging curve of the electric vehicle 202;
the total charging curve 203 (total of the two previous curves);

Three thresholds are also depicted:
a threshold 204 representing the equivalent of the subscriber's subscribed power (12 kVA in the example shown), namely a consumption of 3 kWh over fifteen minutes, assuming operation with cos φ=1;
a first threshold 205, called ‘High_Threshold’, this threshold being a threshold above which the power relay is reopened;
a second threshold 206, called ‘Low_Threshold’, below which the power relay is closed.

It should be noted that the two thresholds 205 and 206 are given for reference only in FIG. 2, since they are not involved in the operation shown in this figure.

The equivalent of subscribed power 204 is clearly exceeded at certain time intervals of the day, indicated by arrows A and B in FIG. 2.

It should also be noted that the duration of a period may differ from the fifteen-minute duration provided by way of example. The duration of the period will be selected so that it is below the duration T1 beyond which the circuit breaker is activated. If this duration T1 is, for example, 20 minutes, a period of 5, 10 or 15 minutes can be selected.

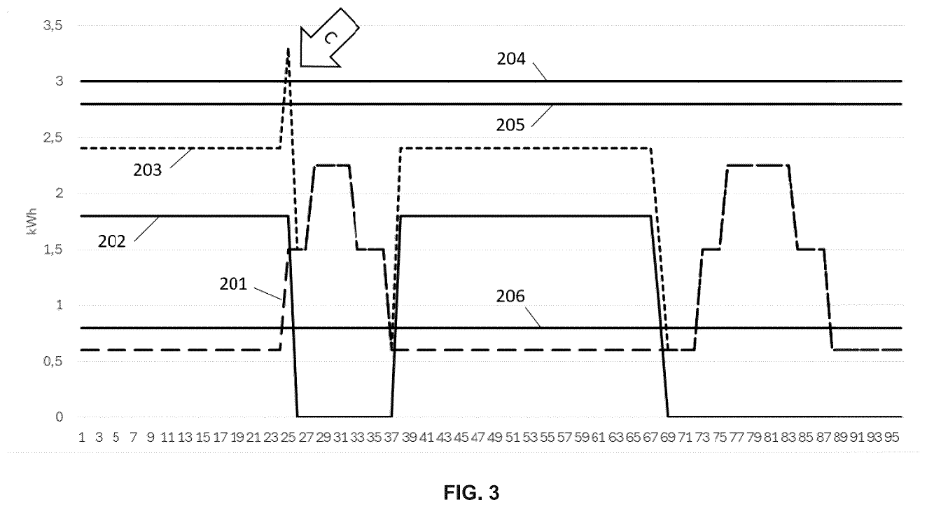

The aim of the present disclosure is to avoid such overruns, or at least to limit them to a duration that does not trigger the meter circuit breaker. FIG. 3 is a graph showing an example of a customer's charging curves as read by the customer's meter when the method described in the present disclosure is applied.

According to a first exemplary embodiment of a method of controlling electric vehicle charging, charging of the electric vehicle is interrupted as soon as consumption over a given period of time exceeds this high threshold (205). Vehicle charging resumes as soon as consumption over a given period of time falls below the low threshold (206). This is hysteresis operation. The high threshold is selected below, but close to, the consumption threshold corresponding to the subscribed power (204). For example, it is a few percentage points below the threshold corresponding to the subscribed power, for example, around 3 to 7% below. The margin taken can also be adjusted empirically and limits the impact of noise in consumption measurements. The closer the high threshold is to the consumption threshold equivalent to the subscribed power, the lower the frequency of power relay opening.

The low threshold is selected close to, but above, a minimum consumption per time period over a day. The margin by which the low threshold lies above this minimum consumption can be of the same order of magnitude as the margin between the high threshold and the consumption threshold corresponding to the subscribed power, in order to limit the impact of noise.

The low and high thresholds may vary, one according to the subscribed power, the other according to changes in the customer's consumption habits and, where applicable, appliances operating autonomously during the day (refrigerators, telecommunications equipment, appliances in standby mode, for example).

In FIG. 3, the consumption threshold 204 corresponding to the subscribed power is thus exceeded only once (arrow ‘C’), and for a limited time, such that the overrun duration T1 of the maximum power is not reached.

A second exemplary embodiment of a method of controlling electric vehicle charging follows the first exemplary embodiment, except that the level of the high threshold depends on the time of day.

According to one embodiment, the level of the high threshold depends on the applicable tariff depending on the time of day, the level of the high threshold being selected to be lower in expensive periods than in less expensive periods. This has the advantage of allowing vehicle charging while reducing the customer's bill, as it favors charging at the least expensive times.

For example, if there is a day rate and a night rate, the high threshold will be set to a first value for the time when the day rate is applicable, and to a second value for the time when the night rate is applicable. The first value is selected lower than the second value, which has the effect of interrupting electric vehicle charging at a lower threshold during the day than at night. The high level of the high threshold can be selected as described above. The low level of the high threshold can be selected so as to trigger every other period. This can be achieved by adding together the minimum consumption recorded over all time periods and the nominal consumption due to a large percentage (for example, 90%) of nominal consumption during charging of the electric vehicle. In fact, charging of the electric car is interrupted at the end of one period and resumed at the end of the next, resulting in charging at 50% of the time when consumption other than that due to vehicle charging is at its minimum level per period.

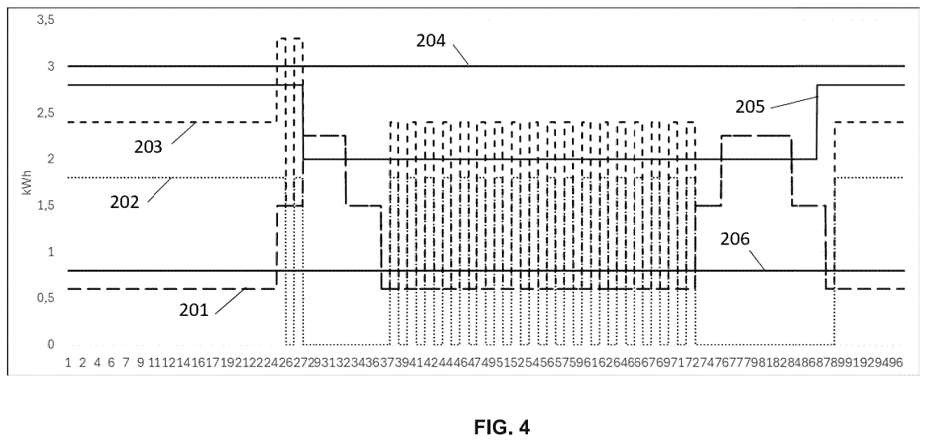

This behavior is illustrated by the graph in FIG. 4. The high threshold 205 here varies between two levels, one during the night (9:30 p.m. to 6:45 a.m., namely, periods 1 to 27 and 87 to 96) and the other during the day (6:45 a.m. to 9:30 p.m., namely, periods 28 to 86). The day level is substantially lower than the night level, resulting in much more frequent interruptions to vehicle charging (curve 203) at the most expensive times, and in the illustrated case, vehicle charging at 50% of the time between periods 37 to 72.

Note that although FIG. 4 illustrates two levels for the high threshold, it is quite possible in other implementations to provide more than two levels.

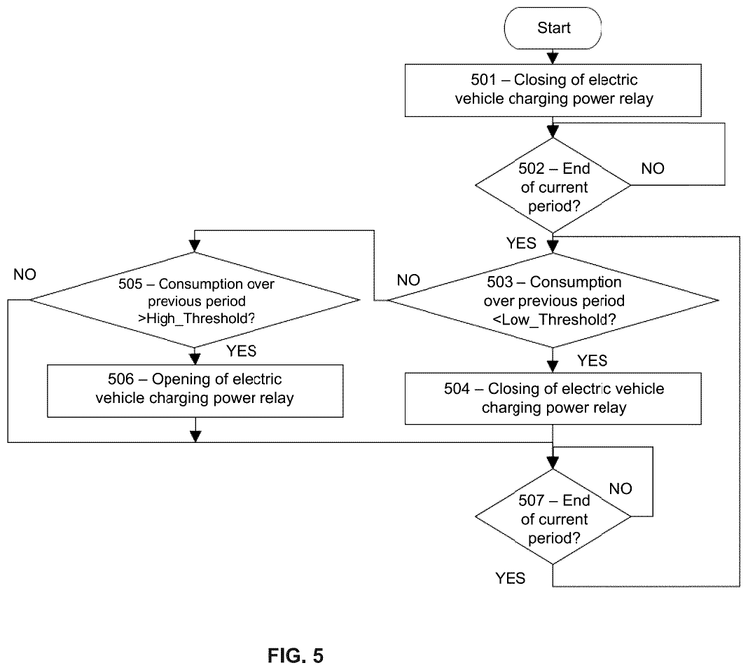

FIG. 5 is a flowchart showing the first embodiment. According to this embodiment:
In 501, the power relay is closed.
In 502, the end of the current period is awaited.
In 503, following the end of the period, referred to as previous period, consumption over this period is compared with the low threshold.
If consumption during the previous period is less than the low threshold, then the power relay is closed in 504, if not already closed. The end of the current period in 507 is awaited, then it returns to 503.
If, however, consumption during the previous period is greater than or equal to the low threshold, it is checked in 505 whether this consumption is greater than the high threshold. If so, the power relay is opened in 506, if it is not already open, then it awaits the end of the current period in 507, then returns to 503. If not, the end of the current period in 507 is awaited, then it returns to 503 to evaluate the most recent completed period.

In the example shown in FIG. 5, the device does not have the shunt 105, or has the shunt but does not use it. According to a variant, the shunt 105 is used to learn the maximum value, Imax, of the current required by the vehicle during a charge and to determine the low and high thresholds on this basis. Imax and the impedance of the shunt 105 are used to determine the maximum power Pmax. Low and high thresholds can be selected as follows:

$${Threshold}_{High} - {Threshold}_{Low} > Emax \qquad [ MATH 1 ]$$

where Emax=Pmax*period duration, which corresponds to the maximum energy required by the electric vehicle when charging during a period. For example, the high threshold can be determined based on the consumption threshold equivalent to consumption over a period (15 minutes in the non-limiting examples shown) at the subscribed power, taking a margin including potential measurement noise, and then using the above relationship to define the low threshold. Of course, the low threshold must also be higher than the minimum consumption of the installation.

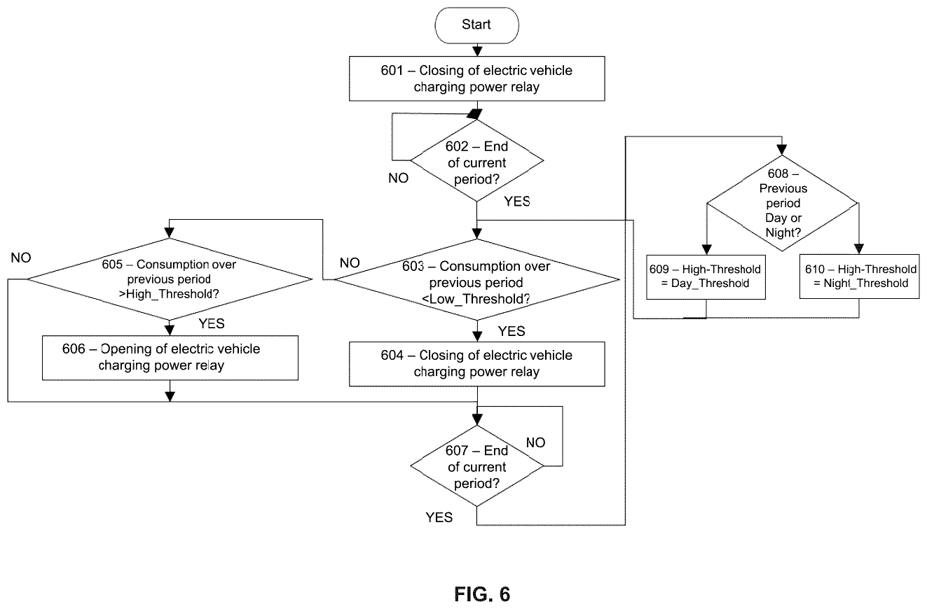

FIG. 6 is a flowchart showing the second embodiment. The phases 601 to 607 in this figure are identical to the phases 501 to 507 in FIG. 5. The high threshold is now modulated depending on the time of day. In the example shown in FIG. 6, after the phase 602, a determination is made in 609 as to whether the previous period is a day or night period. In the first case, the high threshold is taken equal in 609 to its day value (‘Day_Threshold’) and in the second case, the high threshold is taken equal to its night value (‘Night_Threshold’), as explained previously. A comparison of consumption with the low threshold is then undertaken in 603. Note that it is sufficient to adjust the value of the high threshold before comparing consumption with this threshold in 605.

The variant with the shunt 105 is also applicable to the second embodiment.

The person skilled in the art will understand that all the block diagrams presented here represent conceptual views, given by way of example, of circuits incorporating the principles of the disclosure.

Each function, block, and step described can be implemented in hardware, software, firmware, middleware, microcode, or any suitable combination thereof. If implemented in software, the functions or blocks of the block diagrams and flowcharts can be implemented by computer program instructions/software codes, which can be stored or transmitted on a computer-readable medium, or loaded onto a general-purpose computer, special-purpose computer, or other programmable processing device and/or system, such that the computer program instructions or software code running on the computer or other programmable processing device create the means for implementing the functions described in this description.

Although aspects of this disclosure have been described with reference to specific achievements, it should be understood that these achievements merely illustrate the principles and applications of this disclosure. It is therefore understood that numerous modifications can be made to the illustrative embodiments and that other arrangements can be devised without departing from the spirit and scope of the disclosure as determined on the basis of the claims and their equivalents.

Advantages and solutions to problems have been described above with regard to specific embodiments of the invention. However, advantages, benefits, solutions to problems, and any element which may cause or result in such advantages, benefits or solutions, or cause such advantages, benefits or solutions to become more pronounced shall not be construed as a critical, required, or essential feature or element of any or all of the claims.

### LIST OF REFERENCE SIGNS

100—Meter
101—Metrology processor
102—Application processor
103—Circuit breaker
104—Power relay
105—Shunt
106—Shunt
107—Circuit breaker control signal
108—Power relay control signal
109—Electrical outlet

1. A method of controlling the electricity supply to a second group of appliances including at least one appliance, the method being implemented by a device comprising a first processor designed to carry out electricity consumption measurements, a second processor, and a shut-off switch controlled by the second processor to trigger or stop the power supply to the second group, the method comprising:
obtaining, by means of the second processor, the total electricity consumption of a first group of appliances and of the second group of appliances over a period of time, the total electricity consumption being determined by the first processor; the duration of the time period being less than a maximum duration during which the power required by the two groups may be greater than a maximum power to be complied with;
determining whether the total consumption is less than a second threshold, and if so, closing the shut-off switch to enable power supply to the second group;
determining whether the total consumption is greater than a first threshold, and if so, opening the shut-off switch to suspend power supply to the second group;
the first threshold being less than a maximum consumption threshold to be complied with for the total electrical consumption; the second threshold being less than the first threshold, the second threshold being greater than a minimum consumption per period over a time interval including a plurality of consecutive periods of the same duration; and
repeating the previous steps over successive periods of time.

2. The method according to claim 1, wherein the maximum consumption is a function of the maximum power to be complied with.

3. The method according to claim 1, wherein the first threshold has a single value.

4. The method according to claim 1, wherein the first threshold is a function of the time of day.

5. The method according to claim 4, comprising assigning to the first threshold a first value for a first time-dependent electricity tariff and a second value for a second time-dependent electricity tariff, the first tariff being greater than the second tariff and the first value being less than the second value.

6. The method according to claim 1, comprising determining the maximum power, Pmax, required by the second group over said duration, the first threshold and the second threshold being selected to comply with the relationship.
$$First Threshold - Second Threshold > Pmax * duration of a period$$

7. The method according to claim 1, wherein the time interval is one day.

8. The method according to claim 1, wherein the second group of appliances comprises an electric car charger.

9. A device for controlling the electricity supply to a second group of appliances including at least one appliance, the device comprising a first processor designed to carry out electricity consumption measurements, a second processor and a shut-off switch controlled by the second processor to trigger or stop the power supply to the second group, enabling obtaining the total electricity consumption of a second group of appliances and of the first group of appliances over a period of time, the duration of the period of time being less than a maximum duration during which the power required by the two groups may be greater than a maximum power to be complied with, the second processor being configured to drive the device to carry out:
determining whether the total consumption is less than a second threshold, and if so, closing the shut-off switch to enable power supply to the second group;
determining whether the total consumption is greater than a first threshold, and if so, opening the shut-off switch to suspend power supply to the second group;
the first threshold being less than a maximum consumption threshold to be complied with for the total electrical consumption; the second threshold being less than the first threshold, the second threshold being greater than a minimum consumption per period over a time interval including a plurality of consecutive periods of the same duration; and
repeating the previous steps over successive periods of time.

10. The device according to claim 9, wherein the maximum consumption is a function of the maximum power to be complied with.

11. The device according to claim 9, the device being an electricity meter comprising a circuit breaker controlled by the second processor, the circuit breaker being arranged between a phase input of an electricity supply network and the shut-off switch, the power supply to the first group being carried out via a phase between the circuit breaker and the shut-off switch, and the power supply to the second group being carried out via a phase at the output of the shut-off switch.

12. The device according to claim 9, wherein the shut-off switch is a power relay.

13. The device according to claim 9, wherein the shut-off switch is connected to the circuit breaker via a measuring shunt.

14. The device according to claim 9, wherein the output of the shut-off switch is configured to be connected to an electrical outlet suitable for connecting the second group of appliances.

15. The device according to claim 9, wherein the maximum consumption is a function of the maximum power to be complied with.
